(19) United States
(12) Patent Application Publication
(10) Pub. No.: US 2013/0044515 A1
(43) Pub. Date: Feb. 21, 2013

(54) EDGE-TYPE BACKLIGHT MODULE

(71) Applicants: Jen-Chen Lu Feng, Hsin-Chu (TW); Li-Min Hsu, Hsin-Chu (TW)

(72) Inventors: Jen-Chen Lu Feng, Hsin-Chu (TW); Li-Min Hsu, Hsin-Chu (TW)

(73) Assignee: CORETRONIC CORPORATION, Hsin-Chu (TW)

(21) Appl. No.: 13/551,609

(22) Filed: Jul. 18, 2012

(30) Foreign Application Priority Data
Aug. 15, 2011 (CN) 201110236417.4

(51) Int. Cl. F21V 13/12

(52) U.S. Cl. 362/609

(57) ABSTRACT

An edge-type backlight module including a light guide plate, a reflecting element, light emitting elements, and a light absorbing element is provided. The light guide plate includes a first surface, a second surface opposite to the first surface, and at least one light incident surface. The reflecting element is disposed on the second surface and has openings disposed on a side of the reflecting element corresponding to the light incident surface. The light emitting elements are disposed beside the light incident surface and corresponding to the openings, respectively. Each light emitting element emits a light beam which enters the light guide plate via the light incident surface and is transmitted out of the light guide plate via the first surface. The light absorbing element is disposed beneath the reflecting element, supports the reflecting element, and absorbs a part of the light beams entering the openings via the light incident surface.

### CROSS-REFERENCE TO RELATED APPLICATION

This application claims the priority benefit of China application serial no. 201110236417.4, filed on Aug. 15, 2011. The entirety of the above-mentioned patent application is hereby incorporated by reference herein and made a part of this specification.

### BACKGROUND OF THE INVENTION

1. Field of the Invention

The invention relates to a backlight module, and more particularly, to an edge-type backlight module.

2. Description of Related Art

In existing edge-type backlight modules, light emitting elements are disposed beside a light guide plate, and the light guide plate guides light beams emitted by the light emitting elements to a front surface of the light guide plate to form a surface light source. In general, after the light beams emitted by the light emitting elements enter the light guide plate through a side surface of the light guide plate, a majority of the light beams undergo continuous total reflections by top and bottom surfaces of the light guide plate and are thus constrained in the light guide plate. Generally, hot spot phenomenon occurs in edge-type backlight modules which utilize light emitting diodes as the light emitting elements. Hot spot phenomenon refers to a non-uniform illumination phenomenon caused when the light beams enter the light guide plate due to the high directivity of the light emitting diodes. That is, the areas of the light emitting surface of the light guide plate adjacent to the light incident surface corresponding to the light emitting diodes are brighter, while the areas of the light emitting surface of the light guide plate adjacent to the light incident surface not corresponding to the light emitting diodes are darker. For instance, the areas of the light guide plate adjacent to the light incident surface corresponding to locations between adjacent light emitting diodes are darker, thus producing the hot spot phenomenon.

Patents relating to eliminating the hot spot phenomenon include TW Patent Publication Number 200942928 and Patent Number M283201. TW Patent Publication Number 200942928 discloses disposing a covered region in dark color or in black on a reflecting element in order to eliminate the hot spot phenomenon. Patent Number M283201 discloses disposing a cushion between a back plate and a reflecting element to avoid downward deformation of the reflecting element.

### SUMMARY OF THE INVENTION

Accordingly, the invention is directed to an edge-type backlight module which effectively solves the hot spot phenomenon.

Other objects and advantages of the invention can be further illustrated by the technical features broadly embodied and described as follows.

In order to achieve one or a portion of or all of the objects or other objects, one embodiment of the invention provides an edge-type backlight module which includes a light guide plate, a reflecting element, a plurality of light emitting elements, and a light absorbing element. The light guide plate includes a first surface, a second surface opposite to the first surface, and at least one light incident surface connecting the first surface and the second surface. The reflecting element is disposed on the second surface and the reflecting element has a plurality of openings disposed on a side of the reflecting element corresponding to the light incident surface. The light emitting elements are disposed beside the light incident surface and corresponding to the openings, respectively. Each of the light emitting elements is capable of emitting a light beam which enters the light guide plate through the light incident surface and is transmitted out of the light guide plate through the first surface. The light absorbing element is disposed beneath the reflecting element. The light absorbing element supports the reflecting element and is capable of absorbing a part of the light beams entering the openings via the light incident surface.

In one embodiment, the openings are positioned on the side of the reflecting element corresponding to the light incident surface with a specific interval.

In one embodiment, each of the openings is a curved opening.

In one embodiment, a size of each of the openings is equivalent to or bigger than a length of the corresponding light emitting element.

In one embodiment, each of the openings is a half-circle opening.

In one embodiment, the edge-type backlight module further includes a back plate. The back plate includes a support portion at a side of the back plate corresponding to the light emitting elements. The light guide plate and the reflecting element are disposed on the back plate. An accommodation space is formed between the reflecting element and the support portion of the back plate. The light absorbing element is disposed in the accommodation space to support the reflecting element.

In one embodiment, the light absorbing element is an elastic member. The elastic member is in a compressed and deformed state to support the reflecting element when the elastic member is received in the accommodation space.

In one embodiment, each of the light emitting elements is a light emitting diode.

In one embodiment, each of the openings is a polygon opening

In view of the forgoing, the above embodiment of the invention has at least one of the following advantages. The reflecting element has a plurality of the openings at areas corresponding to the light emitting elements, and the light absorbing element is disposed beneath the reflecting element. Due to the light absorption and the reduction of light reflection at areas of the light guide plate that correspond to the light emitting elements, the hot spot phenomenon is mitigated. The light absorbing element is capable of supporting the reflecting element.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

FIG. 1 is a schematic illustration of part of an edge-type backlight module according to one embodiment of the invention.

FIG. 2 is a top view of the edge-type backlight module of FIG. 1.

### DESCRIPTION OF THE EMBODIMENTS

In the following detailed description of the preferred embodiments, reference is made to the accompanying drawings or figures which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purposes of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

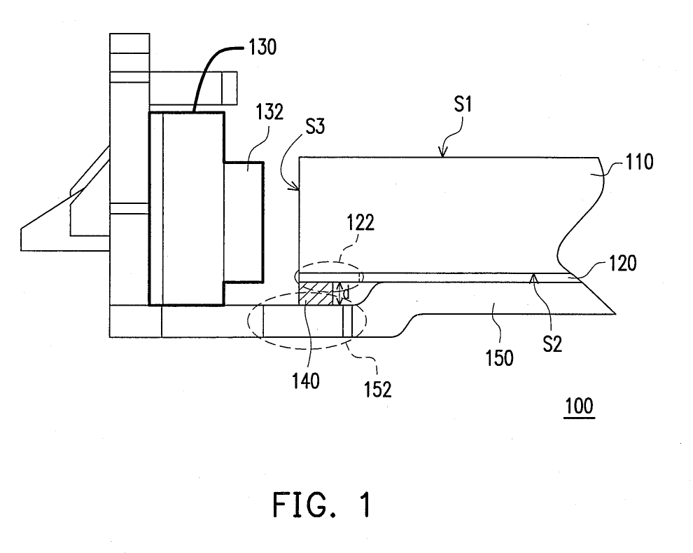

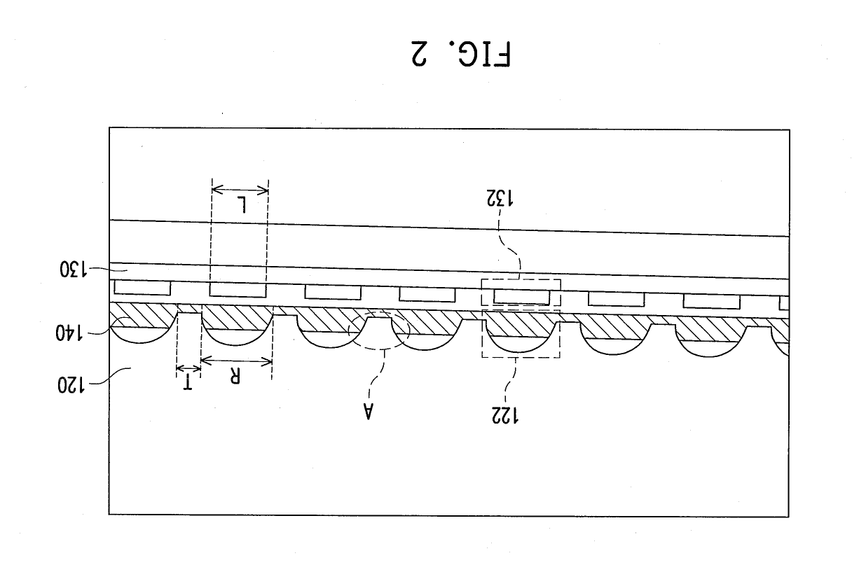

FIG. 1 is a schematic illustration of part of an edge-type backlight module according to one embodiment of the invention. FIG. 2 is a top view of the edge-type backlight module of FIG. 1. Referring to FIG. 1 and FIG. 2, the edge-type backlight module 100 includes a light guide plate 110, a reflecting element 120, a light emitting diode (LED) module 130 and a light absorbing element 140.

The light guide plate 110 includes a first surface S1, a second surface S2 opposite to the first surface S1, and a light incident surface S3. The light incident surface S3 connects the first surface S1 and the second surface S2. The LED module 130 is disposed beside the light incident surface S3 of the light guide plate 110, such that the light beams emitted by the LED module 130 are guided to and transmitted out of the first surface S1 of the light guide plate 110 thus forming a surface light source. Therefore, in this embodiment, the first surface S1 is the light emitting surface of the light guide plate 110.

The edge-type backlight module 100 of the embodiment may further include a back plate 150. The light guide plate 110 and the reflecting element 120 are sequentially disposed on the back plate 150, with the reflecting element 120 attached to the second surface S2. In the embodiment, the reflecting element 120 includes a plurality of openings 122. The openings 122 are positioned at one side of the reflecting element 120 corresponding to the light incident surface S3. In other words, when the reflecting element 120 is disposed beneath the second surface S2 of the light guide plate 110, the openings 122 are formed at one side of the reflecting element 120 corresponding to the side of the light guide plate 110 adjacent to the light incident surface S3. Here, the reflecting element 120 is, for example, a reflecting sheet (e.g. white reflective sheet or silver reflective sheet) for reflecting light beams.

The LED module 130 includes a plurality of light emitting elements 132 such as light emitting diodes. As exemplarily shown in FIG. 2, the light emitting elements 132 are disposed beside the light incident surface S3 and correspond to the openings 122, respectively. Each light emitting element 132 is capable of emitting a light beam which enters the light guide plate 110 through the light incident surface S3 and is transmitted out of the light guide plate 110 through the first surface S1.

In the embodiment, the back plate 150 includes a support portion 152 at one side of the back plate 150 corresponding to the light emitting elements 132. As exemplarily shown in FIG. 1, the support portion 152 is at the side adjacent to light emitting elements 132. An accommodation space is formed between the reflecting element 120 disposed on the back plate 150 and the support portion 152. Here, the light absorbing element 140 is, for example, an elastic member in black. The black elastic member is capable of supporting the reflecting element 120 to avoid downward deformation of the reflecting element 120, in addition to having the capability of the absorbing the light beams emitted from the light emitting elements 132. In particular, in one embodiment, the accommodation space formed between the reflecting element 120 and the support portion 152 has a distance, for example, d. Prior to assembly of the edge-type backlight module 100, the thickness of the light absorbing element 140 is slightly greater than the distance d. Upon assembly, the light emitting element 140 disposed in the accommodation space is in a compressed and deformed state which supports the reflecting element 120 to avoid downward deformation of the reflecting element 120. Here, the light absorbing element 140, as an elastic member, is made of, for example, rubber in black, which achieve the support function as well as the light absorbing result.

Referring to FIG. 1 and FIG. 2, the openings 122 of the embodiment are positioned on the side of reflecting element 120 corresponding to the light incident surface S3 with a specific interval T between two adjacent openings For facilitating fabrication, the openings 122 are, for example, curved openings. The size R of the openings 122 is equivalent to or bigger than the length L (measured in the direction that is parallel to the light incident surface S3 and the first surface S1, as shown in FIG. 2) of the corresponding light emitting element 132. Here, the openings 122 of the embodiment are substantially half-circle openings. However, the openings of the invention are not limited to the half-circle shape. The openings 122 may be of another shape, for example, may be a polygon.

In the embodiment, the reflecting element 120 has openings 122 at areas corresponding to the light emitting elements 132, and the light absorbing element 140 is disposed beneath the reflecting element 120. Therefore, a part of the light beams emitted by the light emitting elements 132 toward the light absorbing element 140 is absorbed by the light absorbing element 140, and the other part of the light beams emitted by the light emitting elements 132 is reflected by the reflecting sheet at areas A between each adjacent openings 122, thus mitigating the non-uniform illumination phenomenon occurring on the side of the light guide plate 110 that faces the LED module 130.

In summary, the above embodiment of the invention has at least one of the following advantages. The reflecting element has a plurality of the openings at areas corresponding to the light emitting elements, and the light absorbing element is disposed beneath the reflecting element. Therefore, due to the absorption of light and the reduction of light reflection at areas of the light guide plate that correspond to the light emitting elements, the hot spot phenomenon is mitigated. The light absorbing element may also be used to support the reflecting element.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the present disclosure is intended to be dedicated to the public regardless of whether the element or component is explicitly recited in the following claims. Each of the terms “first” and “second” used in the specification or claims is only a nomenclature used to modify its corresponding element. These terms are not used to set up the upper limit or lower limit of the number of elements.

What is claimed is:

1. An edge-type backlight module comprising:
a light guide plate comprising a first surface, a second surface opposite to the first surface, and at least one light incident surface connecting the first surface and the second surface;
a reflecting element disposed on the second surface, the reflecting element having a plurality of openings disposed on a side of the reflecting element corresponding to the light incident surface;
a plurality of light emitting elements disposed beside the light incident surface and corresponding to the openings, respectively, each of the light emitting elements being capable of emitting a light beam which enters the light guide plate through the light incident surface and is transmitted out of the light guide plate through the first surface; and
a light absorbing element disposed beneath the reflecting element, the light absorbing element supporting the reflecting element and being capable of absorbing a part of the light beams entering the openings via the light incident surface.

2. The edge-type backlight module according to claim 1, wherein the openings are positioned on the side of the reflecting element corresponding to the light incident surface with a specific interval between two adjacent openings.

3. The edge-type backlight module according to claim 1, wherein each of the openings is a curved opening.

4. The edge-type backlight module according to claim 3, wherein a size of each of the openings is equivalent to or bigger than a length of the corresponding light emitting element.

5. The edge-type backlight module according to claim 3, wherein each of the openings is a half-circle opening.

6. The edge-type backlight module according to claim 1, further comprising:
a back plate comprising a support portion at a side of the back plate corresponding to the light emitting elements, the light guide plate and the reflecting element being disposed on the back plate, an accommodation space being formed between the reflecting element and the support portion of the back plate,
wherein the light absorbing element is disposed in the accommodation space to support the reflecting element.

7. The edge-type backlight module according to claim 6, wherein the light absorbing element is an elastic member and the elastic member is in a compressed and deformed state to support the reflecting element when the elastic member is received in the accommodation space.

8. The edge-type backlight module according to claim 1, wherein each of the light emitting elements is a light emitting diode.

9. The edge-type backlight module according to claim 1, wherein each of the openings is a polygon opening.
